(19) United States
(12) Patent Application Publication
(10) Pub. No.: US 2011/0183157 A1
(43) Pub. Date: Jul. 28, 2011

(54) METHOD FOR MANUFACTURING OF BUILDING BOARDS

(76) Inventor: Peter Lindberg, Orebro (SE)

(21) Appl. No.: 13/121,640

(22) PCT Filed: Oct. 7, 2009
(86) PCT No.: PCT/SE09/51117

§ 371 Date: Mar. 29, 2011

(30) Foreign Application Priority Data
Oct. 13, 2008 (SE) 0802184-2

(51) Int. Cl. B32B 13/00; B32B 37/00

(52) U.S. Cl. 428/703; 156/39

(57) ABSTRACT

A method for manufacturing of building boards is described. The method comprises the steps to arrange a first reinforcement layer on an underlayer such that the first reinforcement layer is essentially flat, the first reinforcement layer comprising a first side edge and a second side edge, to arrange a first edge strip having a length axis along the first side edge with the length axis being parallel to the first side edge, to arrange a hardenable substance on the first reinforcement layer in contact with the first edge strip, to arrange a second reinforcement layer on the hardenable substance such that the second reinforcement layer is essentially parallel to the first reinforcement layer, and to harden the hardenable substance.

### TECHNICAL AREA

The present invention pertains to a method for manufacturing of building boards for buildings. In particular, the invention relates to a method for manufacturing of essentially homogenous building boards of cement, plaster or the like, which on two opposite sides are provided with sheets of a different material.

### DESCRIPTION OF THE PRIOR ART

When building walls, floors and ceilings building boards of different kinds are commonly used to attain a rational building. There are many kinds of building boards, such as for example wood fiber boards, laminated boards and plasterboards which often are referred to as gypsum wallboards. If a fireproof board is required gypsum wallboards are often used. If it is desired that the board also be waterproof a type of gypsum wallboard can be used which is cement based. According to the prior art, gypsum wallboards include a board of plaster between two sheets of glass fiber reinforced paper. The gypsum wallboards are manufactured by pouring out a floating plaster substance on one of the paper sheets and there after applying the other paper sheet. Finally, the gypsum wallboard is dried by applying heat. After that gypsum wallboards have been mounted for example on a wall the junctions between the gypsum wallboards are visible, which is not aesthetically appealing. To render the junction more aesthetically appealing the junctions are glazed so that the wall becomes flat. Gypsum wallboards which are used for ceilings are often provided with a chamfered edge so that the junctions attain the shape of a V-shaped groove.

It would however be desirable to provide boards by means of which it is possible to attain a flat ceiling and flat walls without having to glaze the junctions between the boards, and at the same time, the boards are non-combustible.

Flatter junctions between building boards can be obtained if the edges of the building boards are provided with grooves which can grip into one another. However, cement and plaster are too brittle materials to withstand the milling of such grooves in the edges of the building boards.

The U.S. Pat. No. 3,988,679 describes a method of applying reinforcing strips to the edges of building boards. The patent discloses building boards of plaster or cement which have reinforcement layers on two opposing sides. The plaster/cement between the reinforcement layers is milled off along one edge or along two parallel edges of the board. Thereafter, edge strips are glued between the reinforcement layers in the milled grooves. Each of the edge strips is arranged to grip into a strip of a neighboring board. The strips may be made of any material, such as metal or plastic.

The method being described in said US patent requires machine processing of the board's edges, which in addition to being time consuming also produces dust that must be taken care of. The gluing of the strips in the grooves is likewise time consuming.

### SUMMARY OF THE INVENTION

An object of the present invention is to provide a method for manufacturing of a cast building board with reinforced edges, which method is an alternative to the known manufacturing methods.

Another object of the present invention is to provide a method for manufacturing a cast building board with reinforced edges, which method is less complex than the known manufacturing methods.

At least one of these objects is attained via a method according to the independent claim.

Additional advantages of the invention are attained via the features of the dependent claims.

A basic idea of the present invention is to arrange edge strips along at least one side edge of a cast building board in connection with casting the board.

A method according to the invention for manufacturing of building boards comprises the step to arrange a first reinforcement layer on an underlayer such that the first reinforcement layer is essentially flat, the first reinforcement layer comprising a first side edge and a second side edge. The method also comprises the step to arrange a first edge strip having a length axis along the first side edge with the length axis parallel to the first side edge and the step to arrange a hardenable substance on the first reinforcement layer in contact with the first edge strip. Additionally, the method comprises the steps to arrange a second reinforcement layer on the hardenable substance such that the second reinforcement layer is essentially parallel to the first reinforcement layer, and to harden the hardenable substance.

According to a preferred embodiment, the steps are executed in said order.

The reinforcement layers may be arranged in a large number of ways. For example the reinforcement layers may be arranged from a roll, wherein the reinforcement layer is cut after the arranging, or in the form of a sheet. In the latter case, each of the first reinforcement layer and the second reinforcement layer may be represented by one or more sheets.

The arranging of edge strips in building boards is facilitated by employing the method according to the invention. The edge strip may either be profiled before or after arranging thereof in the building board. When profiling the strip before arranging it in the building board, the profiling may be effected either by casting it into a desired shape or by processing. Since the edge strip is a separate piece when manufacturing the building board it may be manufactured in a material being more suited for processing than the hardenable substance. The step of milling grooves in a cast building board according to the procedures of the prior art can be excluded if grooves in the edge strip have been created before the edge strip was arranged in the building board. Otherwise, grooves are milled in a material being easier to process than the cast building board. Thereby substantial amounts of time are saved when manufacturing the board. Furthermore, good adherence of the edge strip to the building board is attained because the edge strip is cast into the building board. Moreover, the invention renders it possible to use edge strips whose profile at the interface towards the hardenable substance is more advantageous from a resistance point-of-view. The methods according to the prior art have exclusively enabled the use of edge strips whose profile allowed insertion into a milled groove.

The first edge strip may be arranged in contact with at least one of the reinforcement layers. By allowing the edge strip to be in contact with the reinforcement layers a stronger junction between the first edge strip and the hardenable substance is made possible.

The first edge strip may be arranged between the reinforcement layers. By arranging the first edge strip in said manner a stronger junction between the first edge strip and the hardenable substance is made possible.

The method may include the step to glue the first edge strip to at least one of the reinforcement layers. By gluing the first edge strip to the reinforcement layers a stronger junction between the first edge strip and the hardenable substance is obtained.

The method may include the step to arrange a second edge strip along the second side edge, the second edge strip being arranged with its length axis parallel to the second side edge. The edge strips along both side edges renders it possible to attain smooth junctions on both sides of the building board in a simpler manner. Having edge strips along both side edges enables connecting the building board to building boards on both sides of the building board.

The first side edge may be essentially parallel to the second side edge. Such building boards are less complex to manufacture than building boards that do not have parallel side edges. Moreover, it is simpler to use such building boards during building.

Analogous to what has been described above, the second edge strip may be arranged in contact with at least one of the reinforcement layers. By arranging the second edge strip in this way a stronger junction between the second edge strip and the hardenable substance is made possible.

Analogous to what has been described above, the first edge strip may be arranged in contact with at least one of the reinforcement layers. By arranging the second edge strip in this way a stronger junction between the second edge strip and the hardenable substance is made possible.

The method may include the step to glue the second side edge to at least one of the reinforcement layers. By gluing the second edge strip to the reinforcement layers a stronger junction between the hardenable substance and the second edge strip is attained.

The edge strips may be cut to a final length before arranging them on the reinforcement layer. Edge strips of fixed lengths may be arranged in a magazine from which they are arranged onto the reinforcement layer. Alternatively, the edge strips may be cut to a final length after hardening of the hardenable substance for a rational manufacturing procedure. The latter alternative enables rolling out the edge strips from a roll in convection with manufacturing of the building boards, which results in a rational manufacturing procedure. As yet another alternative, the edge strips may be accomplished by a spraying a hardening edge strip substance.

The hardenable substance may for example be cement based or plaster based, however also other hardenable substances are possible to use. The hardenable substance is suitably selected with respect to the intended area of use for the building board.

The hardenable substance may include reinforcement fibers to increase the structural strength of the board.

The edge strips may be made of a wide variety of different materials. The choice of material of the edge strips is preferably made depending on the indented area of use for the building board. Wood, polymers, pressed fibers and metals constitute examples of materials. The interface between the edge strip and the plaster or cement board may be arranged in many different ways. The interface may be flat, however it is also possible to have the edge strip partially cast into the plaster to enhance the structural strength of the junction. The side of the edge strip that faces away from the plaster or cement board may be arranged in many different ways. For example the edge strip may be arranged to grip into a neighboring edge strip of a neighboring board.

According to the invention, edge strips may be arranged along the first side edge and the second side edge. The first side edge and the second side edge are preferably essentially parallel to one another. Thus, no edge strips are arranged perpendicular to the first side edge and the second side edge. This is advantageous especially in connection with continuous manufacturing along a conveyor belt where the hardenable substance is hardened before cutting the building board across the edge strips.

Subsequently, preferred embodiments of the invention will be described with reference to the attached drawings.

### BRIEF DESCRIPTION OF THE DRAWINGS

FIG. 1 schematically shows the first step of a method according to an embodiment of the invention.

FIG. 2 schematically shows the second step of the method.

FIG. 3 schematically shows the third step of the method.

FIG. 4 schematically shows the fourth step of the method.

FIG. 5 schematically shows the fifth step of the method.

FIG. 6 schematically shows a building board manufactured via a method according to the present invention.

FIG. 7 schematically shows a processing line for manufacturing of cast building boards according to the described method.

FIG. 8 schematically shows a processing line for executing additional processing steps on a finished board.

### DESCRIPTION OF PREFERRED EMBODIMENTS OF THE INVENTION

In the following description of preferred embodiments of the invention, similar parts will in different figures be denoted with the same reference signs. The drawings are only schematic and are intended to illustrate the invention.

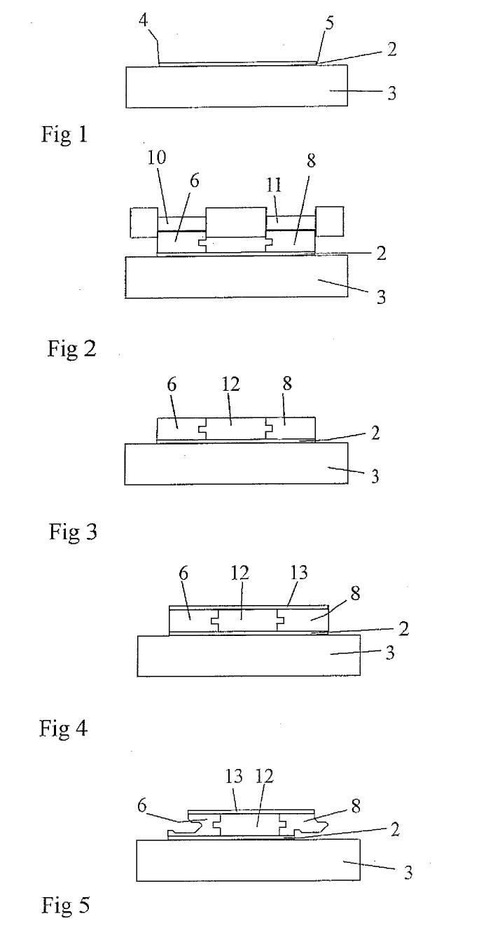

In FIG. 1-5 different steps are shown of a method according to an embodiment of the invention for manufacturing a building board 1.

FIG. 1 schematically shows the first step of the method. In the first step, a first reinforcement layer 2 is arranged on an underlayer 3, such that the first reinforcement layer 2 is essentially flat. The first reinforcement layer 2 includes a first side edge 4 and a second side edge 5. Glue is applied along the side edges 4 and 5 on the upper side of the reinforcement layer that faces away from the underlayer 3.

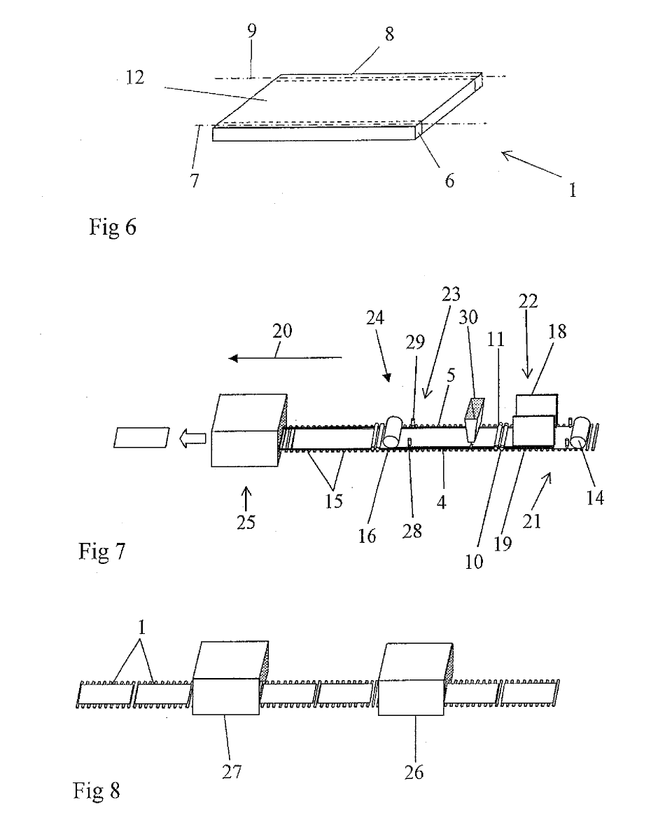

FIG. 2 schematically shows the second step of the method. In the second step, a first edge strip 6 having a length axis 7 (FIG. 6) is arranged along the first side edge 4 with its length axis 7 parallel to the first side edge 4. In the second step a second edge strip 8 having a length axis 9 (FIG. 6) is also arranged along the second side edge 5 with its length axis 9 parallel to the second side edge 5. The edge strips 6 and 8 may for example be arranged on the first reinforcement layer by means of a type of glue. As an alternative to applying glue on the upper side of the reinforcement layer, glue or tape may be applied on the strips before being arranged on the reinforcement layer. The first edge strip 6 and the second edge strip 8 are fed out continuously from a first edge strip magazine 18 (FIG. 7) and a second edge strip magazine 19 (FIG. 7) respectively. In order to improve the adherence the edge strips 6 and 8 may be subjected to pressure from a pressuring means in the form of rolls 10 and 11, which may be rolled at pressure over the edge strips 6 and 8 in the length directions 7 and 9 of the edge strips 6 and 8. As is apparent from FIG. 2, the edge of the edge strips 6 and 8 does not need to be straight, but may also have an uneven profile to render the adherence between the edge strips 6 and 8 and the hardening substance 12 as good as possible.

FIG. 3 schematically shows the third step of the method. In the third step, a hardenable substance 12 is arranged on the first reinforcement layer 2 in contact with the first edge strip 6 and the second edge strip 8. The hardenable substance 12 may for example be cement based or plaster based, but it is possible to use also other hardenable substances 12.

FIG. 4 schematically shows the fourth step of the method. In the fourth step, glue is possibly applied on the upper sides of the edge strips 6 and 8 that face away from the first reinforcement layer 2. Thereafter, a second reinforcement layer 13 is arranged on the edge strips 6 and 8, and the hardenable substance 12. After that the second reinforcement layer 13 has been applied to the hardenable substance 12 and the edge strips 6 and 8 the hardenable substance 12 is hardened, which for example can be effected by drying and/or heat processing.

FIG. 5 schematically shows the fifth step of the method. In the fifth step the edge strips are profiled to obtain the desired edge profile. In the shown embodiment, the edge strips 6 and 8 have been given profiles for a so-called “click joint”, which means that the first edge strip 6 has a shape that renders it adapted to be fitted into an edge strip having the shape of the second edge strip 8.

FIG. 6 schematically shows a building board 1 manufactured according to the present invention. The building board 1 includes a first edge strip 6 having a length axis 7 and a second edge strip 8 having a length axis 9 between which edge strips 6 and 8 a hardenable substance 12 is arranged.

In FIG. 7 a processing line is shown for manufacturing of cast building boards according to the described method along a process direction 20. At 21 the first reinforcement layer 2 is rolled out from a first roll 14 onto an underlayer in the form of transport rolls 15 at the same time as glue is applied onto the first reinforcement layer 2 at the side edges 4 and 5. At 22 the edge strips 6 and 8 are applied from a first edge strip magazine 18 and a second edge strip magazine 19 respectively, and the hardening substance 12 onto the first reinforcement layer 2 from the distribution container 30. Thereafter, the edge strips 6 and 8 are pressed in place onto the first reinforcement layer 2 by means of the rolls 10 and 11. At 23 glue is also applied on the edge strips 6 and 8 via the glue spreaders 28 and 29. At 24 the second reinforcement layer 13 is applied from a second roll 16 onto the edge strips 6 and 8, and the hardening substance 12. At 25 drying is executed and cutting to accomplish the finished building boards 17.

In FIG. 8 a processing line is shown for executing additional process steps. At 26 edge profiling of the edge strips 6 and 8 is possibly performed. Alternatively, this step may be executed prior to bringing the edge strips 6 and 8 into place on the first reinforcement layer. At 27 the finished building boards 17 are painted.

The described embodiments may be varied in many ways without departing from the spirit and scope of the invention which is only delimited by the associated claims.

It is not necessary to arrange the edge strips from an edge strip magazine as described above. It is also possible to arrange edge strips from a roll or to extrude the edge strips in the form of a hardenable edge strip substance of a different kind than the hardenable substance between the edge strips.

It is not necessary to perform the profiling of the edge strips after arranging them in the building board. Alternatively, the profiling may be done already before arranging the edge strips in the building board.

1. A method for manufacturing of building boards, the method comprising:
arranging a first reinforcement layer on an underlayer such that the first reinforcement layer is essentially flat, the first reinforcement layer comprising a first side edge and a second side edge,
arranging a first edge strip having a length axis along the first side edge with the length axis parallel to the first side edge,
arranging a hardenable substance on the first reinforcement layer in contact with the first edge strip,
arranging a second reinforcement layer on the hardenable substance such that the second reinforcement layer is essentially parallel to the first reinforcement layer, and
hardening the hardenable substance.

2. The method according to claim 1, wherein the first edge strip is arranged in contact with at least one of the reinforcement layers.

3. The method according to claim 2, wherein the first edge strip is arranged between the reinforcement layers.

4. The method according to claim 3, comprising gluing the first edge strip to at least one of the reinforcement layers.

5. The method according to claim 1, comprising arranging a second edge strip along the second side edge, the second edge strip having a length axis being parallel to the second side edge.

6. The method according to claim 5, wherein the first side edge is essentially parallel to the second side edge.

7. The method according to claim 5, wherein the second edge strip is arranged in contact with at least one of the reinforcement layers.

8. The method according to claim 7, wherein the second edge strip is arranged between the reinforcement layers.

9. The method according to claim 8, comprising gluing the second edge strip to at least one of the reinforcement layers.

10. The method according to claim 1, wherein the edge strips are cut to a final length before arranging them on the first reinforcement layer.

11. The method according to claim 1, wherein the edge strips are cut to a final length after the hardening of the hardenable substance.

12. The method according to claim 1, wherein the hardenable substance is cement based.

13. The method according to claim 1, wherein the hardenable substance is plaster based.

14. The method according to claim 1, wherein the hardenable substance comprises reinforcement fibers.

15. The method according to claim 1, wherein the edge strips are made of plastic.

16. The method according to claim 1, wherein the edge strips are made of metal.

17. The method according to claim 1, wherein edge strips are arranged exclusively along the first side edge.

18. The method according to claim 1, wherein edge strips are arranged exclusively along the first side edge and the second side edge.

19. The method according to claim 1 comprising extruding at least one edge strip by spraying a hardening edge strip substance onto the first reinforcement layer.

20. A building board manufactured by a method comprising:
arranging a first reinforcement layer on an underlayer such that the first reinforcement layer is essentially flat, the first reinforcement layer comprising a first side edge and a second side edge,
arranging a first edge strip having a length axis along the first side edge with the length axis parallel to the first side edge,
arranging a hardenable substance on the first reinforcement layer in contact with the first edge strip,
arranging a second reinforcement layer on the hardenable substance such that the second reinforcement layer is essentially parallel to the first reinforcement layer, and
hardening the hardenable substance.
